(19) United States
(12) Patent Application Publication
(10) Pub. No.: US 2025/0312636 A1
(43) Pub. Date: Oct. 9, 2025

(54) APPARATUS FOR CONFIGURING FIRE SAFETY DEVICES IN AN ENVIRONMENT AND A METHOD THEREOF

(71) Applicant: Kidde Fire Protection, LLC, Bradenton, FL (US)

(72) Inventors: Murali Mahendra Kumar Banala, Hyderabad/Telangana (IN); Venkateshwar Rao Mucherla, Hyderabad/Telangana (IN); Venkata Satya Surya Gayatri Kumar Gudala, Hyderabad/Telangana (IN); Veera Satya Srinivasu Anupoju, Hyderabad/Telangana (IN)

(21) Appl. No.: 19/097,244

(22) Filed: Apr. 1, 2025

Related U.S. Application Data
(60) Provisional application No. 63/575,850, filed on Apr. 8, 2024.

(51) Int. Cl. A62C 37/36; G05B 17/02; G06K 7/14

(52) U.S. Cl. CPC A62C 37/04; G05B 17/02; G06K 7/1417

(57) ABSTRACT

An apparatus and a method for configuring fire safety devices in an environment. The method includes receiving an input including one or more machine-readable codes corresponding to one or more fire safety devices. The method also includes generating a floor-based plan of the environment including positional information of each of the one or more fire safety devices based on the received machine-readable code. The method further includes configuring each of the one or more fire safety devices based on the corresponding positional information in the generated floor-based plan.

### CROSS-REFERENCE TO RELATED APPLICATIONS

This application claims priority to U.S. Provisional Application No. 63/575,850 filed Apr. 8, 2024, all of which are incorporated herein by reference in their entirety.

### FIELD OF THE INVENTION

The disclosure generally relates to fire control systems, and more particularly relates methods and systems for configuring fire safety devices in an environment using machine-readable codes.

### BACKGROUND

Fire control systems in large facilities, like commercial buildings, offices, and hospitals, serve to detect and manage fires. These systems comprise various components distributed throughout the facility. Examples include sensors such as smoke detectors for fire detection, alarms to alert occupants, and mechanisms like fans or dampers for smoke control. Sprinkler systems may also be part of the setup for fire suppression.

A key element of a fire control system is the physical control panel installed within the facility, allowing users to manage system operations. Additionally, there may be a centralized workstation, either within the facility or remotely located. This workstation typically includes a computing device enabling users to analyze and configure a premise's fire safety.

In general, analyzing and configuring of a premise's fire safety is done manually by a technician. The process requires a lot of time to manually analyze and understand the premise's blueprint to configure the various components of the fire control systems and their functionality.

Therefore, in view of the above-mentioned problems, there is a need to provide an improved technique for configuring fire safety devices in an environment.

### BRIEF DESCRIPTION

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

Disclosed herein is a method for configuring fire safety devices in an environment. The method includes receiving an input comprising one or more machine-readable codes corresponding to one or more fire safety devices. Each of the one or more machine-readable codes includes at least one of device model information and a logical path associated with the corresponding fire safety device. The method also includes generating a floor-based plan of the environment including positional information of each of the one or more fire safety devices based on the received one or more machine-readable codes. Thereafter, the method includes configuring each of the one or more fire safety devices based on the corresponding positional information in the generated floor-based plan.

In one or more embodiments, the method includes receiving, via a scanning device, the one or more machine-readable codes.

In one or more embodiments, the method includes receiving a Computer Aided Design (CAD) file including the one or more machine-readable code.

In one or more embodiments, for configuring each of the one or more fire safety devices, the method includes assigning the one or more fire safety devices to at least one operational node configured to control operation of the one or more fire safety devices.

In one or more embodiments, prior to receiving the input, the method includes assigning, to each of the one or more fire safety devices, a machine-readable code to store at least one of the device model information and the logical path associated with the corresponding fire safety device. The method also includes generating the CAD file with one or more machine-readable codes placed at a designated location of the corresponding one or more fire safety devices.

In one or more embodiments, for configuring each of the one or more fire safety devices, the method includes configuring each of the one or more fire safety devices. The method also includes identifying a number of operational nodes based on the determined number of fire safety devices. The method further includes assigning the one or more fire safety devices to the at least one operation node based on the identified number of operational nodes.

In one or more embodiments, the method includes displaying the generated floor-based plan to a user via a user interface.

In one or more embodiments, the method also includes receiving, via a user interface, one or more user inputs corresponding to the generated floor-based plan of the environment. The method also includes modifying the generated floor-based plan based on the received one or more user inputs.

In one or more embodiments, the CAD file corresponds to a building map.

In one or more embodiments, the one or more machine-readable codes correspond to a Quick Response (QR) code.

Also disclosed herein is an apparatus for configuring fire safety devices in an environment. The apparatus comprises a memory and at least one processor communicably coupled with the memory. The at least one processor is configured to receive an input comprising one or more machine-readable codes corresponding to one or more fire safety devices. Each of the one or more machine-readable codes includes at least one of device model information and a logical path associated with the corresponding fire safety device. The at least one processor is configured to generate a floor-based plan of the environment including positional information of each of the one or more fire safety devices based on the received one or more machine-readable codes. The at least one processor is further configured to configure each of the one or more fire safety devices based on the corresponding positional information in the generated floor-based plan.

In one or more embodiments, the at least one processor is configured to receive, via a scanning device, the one or more machine-readable codes.

In one or more embodiments, the at least one processor is configured to receive a Computer Aided Design (CAD) file including the one or more machine-readable code.

In one or more embodiments, to configuring each of the one or more fire safety devices, the at least one processor is configured to assign the one or more fire safety devices to at least one operational node configured to control operation of the one or more fire safety devices.

In one or more embodiments, prior to receiving the input, the at least one processor is configured to assign, for each of the one or more fire safety devices, a machine-readable code to store at least one of the device model information and the logical path associated with the corresponding fire safety device. The at least one processor is further configured to generate the CAD file with one or more machine-readable codes placed at a designated location of the corresponding one or more fire safety devices.

In one or more embodiments, to configure each of the one or more fire safety devices, the at least one processor is configured to determine a number of fire safety devices from the received input. The at least one processor is configured to identify a number of operational nodes based on the determined number of fire safety devices. The at least one processor is further configured to assign the one or more fire safety devices to the at least one operation node based on the identified number of operational nodes.

In one or more embodiments, the at least one processor is configured to display the generated floor-based plan to a user via a user interface.

In one or more embodiments, the at least one processor is configured to receive, via a user interface, one or more user inputs corresponding to the generated floor-based plan of the environment. The at least one processor is configured to modify the generated floor-based plan based on the received one or more user inputs.

To further clarify the advantages and features of the methods, systems, and apparatuses, a more particular description of the methods, systems, and apparatuses will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an exemplary system environment of a configuration device for configuring fire safety devices in an environment, according to one or more embodiments of the present disclosure;

FIG. 2 illustrates a schematic block diagram of the configuration device, according to one or more embodiments of the present disclosure;

FIG. 3 illustrates a user interface representing configuration of the fire safety devices by the configuration device, according to one or more embodiments of the present disclosure; and

FIG. 4 illustrates a process flow depicting a method for configuring the fire safety devices in the environment, according to one or more embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, “some embodiments”, “one or more embodiments” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the disclosure will be described below in detail with reference to the accompanying drawings.

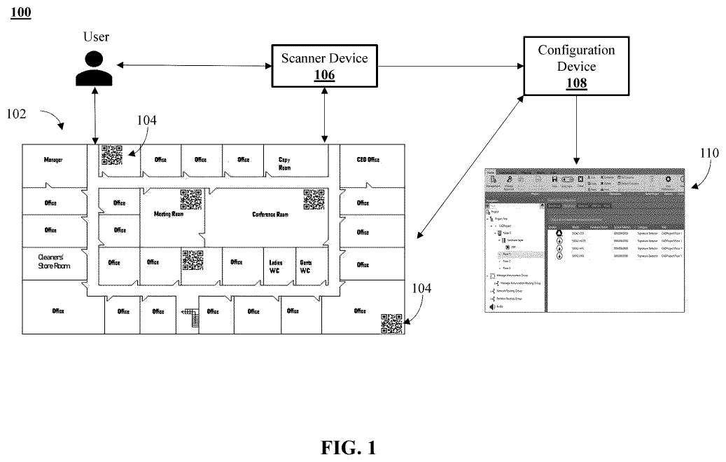

FIG. 1 illustrates an exemplary system environment 100 of a configuration device 108 for configuring fire safety devices in an environment, according to one or more embodiments of the present disclosure. The system environment 100 illustrates a user, a floor layout 102, a scanner device 106, and the configuration device 108.

The user may be a technician, a safety engineer or manager, a fire safety inspector, a maintenance technician, a security personnel, or any other authorized personnel. The user may be responsible to access the configuration device 108 to configure and/or view the fire safety devices in an environment. The user may utilize the configuration device 108 to ensure compliance with safety regulation and protocols via the effective commissioning of the fire safety devices in the environment. The user may access the configuration device 108 to monitor, maintain, and/or update fire safety devices configuration in the environment. In some embodiments, the user may access the configuration device 108 to evaluate and assess compliance and recommend improvements in the configuration of the fire safety devices in the environment. The user may also access the configuration device 108 to troubleshoot issues, update firmware, or conduct routine inspections of the fire safety devices in the environment. In an exemplary embodiment, the user may utilize the configuration device 108 to configure the fire safety devices in the environment. The environment may correspond to an industrial plant, residential building, commercial buildings, healthcare facilities, etc.

The fire safety devices may correspond to fire detection systems, fire suppression systems, and emergency lighting systems. The fire detection systems may include devices, such as, but not limited to, smoke detectors, heat detectors, flame detectors, gas detectors, and the like. The fire suppression systems may include devices such as, but not limited to, sprinklers, fire extinguishers, foam systems, and the like. A position of the fire safety devices in the environment may be provided to the user via the floor layout 102.

The floor layout 102 may correspond to a visual representation of an arrangement of spaces, rooms, corridors, and other features on a single floor level of the building (i.e., the environment). The floor layout 102 may provide a bird's-eye view of how different areas are organized within the building/environment, and serves as a blueprint for construction, renovation, or emergency planning. The floor layout 102 includes components such as, room and spaces, corridors and hallways, and entrance and exits. The floor layout 102 also includes positioning information corresponding to various other functional components of the building such as, piping, safety devices, alarm devices, lighting and so forth. In an exemplary embodiment, the floor layout 102 has been illustrated with different fire safety devices represented via a corresponding machine-reading code 104. The machine-readable code 104 may store information associated with the corresponding fire safety device. The information stored in the machine-readable code 104 may include, but is not limited to, a type of device, a location of the device, a functionality of the device, connection points, and/or maintenance information.

In one embodiment, the floor layout 102 may be stored in a Computer-Aided Design (CAD) file. The CAD file provides precise and detailed information about various components of the floor layout and the associated devices of the building. In one embodiment, the CAD file may define the design element of the floor layout with predefined measurements and specifications. In alternative embodiment, the user may have the floor layout 102 in physical form, for example, printed on a paper.

The floor layout 102 may be embedded with the one or more machine readable codes 104. In an exemplary embodiment, the one or more machine readable codes may correspond to the one or more fire safety devices to be installed and/or configured in the building/environment. In alternative embodiment, the one machine readable codes may correspond to other safety devices of the building/environment. In one embodiment, the one or more machine readable codes 104 may correspond to a Quick Response (QR) code. In other embodiments, the one or more machine readable codes 104 may correspond to any other suitable codes configured to store and access digital information. In an embodiment, the one or more machine readable codes 104 may include information such as, a model of the fire safety device, a physical location of the fire safety device with respect to the building/floor, and a Global Unique Identifier (GUID), associated with the corresponding one or more fire safety devices. The GUID may be a 128-bit text string that may represent an identification of the fire safety device according to a predefined standard. The model of the fire safety device may indicate a type of the fire safety device such as, but not limited to, a smoke detector, a heat detector, a gas (CO) detector, a pull station, and so forth. The physical location of the fire safety device may indicate a specific geographical location with respect to floor layout 102. In one non-limiting embodiment, the physical location may be represented in the below format:

X1:X2:X3: . . . :Xn where Xn is portion of area in the X(n−1); and

X1:Y2:Y3: . . . :Yn where X2 and Y2 are two different portions of area under the X1 and so on.

For example, a location of the fire safety device may be represented as:

X1 (Building 9):X2 (Cafeteria):X3 (Kitchen)

X1 (Building 9):Y2 (Workstation Area):Y3 (Conference Room)

Thus, the one or more machine readable codes 104 include the essential information related to the corresponding one or more fire safety device, that enables the user to configure the fire safety devices in an effective and efficient manner.

In an embodiment, the CAD file corresponding to the floor layout 102 may be fed to the configuration device 108. In one embodiment, the configuration device 108 may be configured to parse the CAD file and identify the one or more machine readable codes 104. In alternative embodiment, the user may use the scanner device 106 communicably coupled with the configuration device 108 to read the one or more machine readable codes 104 from the floor layout 102. Thereafter, the scanner device 106 shares the one or more machine readable codes 104 to the configuration device 108. Examples of the scanner device 106 may include, but are not limited to, a smartphone, a tablet, a QR code scanner, a handheld optical scanner device, and the like.

The scanner device 106 may be connected with the configuration device 108 via any suitable wired and/or wireless communication means. Examples of such communication means include, but are not limited to, Universal Serial Bus (USB) port, Bluetooth, Wi-Fi, serial ports, Ethernet, and so forth.

In an exemplary embodiment, the configuration device 108 may be configured to receive the one or more machine readable codes 104 from the scanner device 106 or read the one or more machine readable codes 104 from the CAD file corresponding to the floor layout 102. In particular, the configuration device 108 may receive an input comprising the one or more machine-readable codes 104 corresponding to the one or more fire safety devices of the building. The configuration device 108 may configure to parse the received input and identify the one or more safety devices corresponding to the floor layout 102.

The configuration device 108 may be configured to generate a floor-based plan (may interchangeably be referred to as a “the project”) of the environment including positional information of each of the one or more fire safety devices based on the received machine-readable codes. In an embodiment, the configuration device 108 may assign the one or more fire safety devices to at least one operational node configured to control operation of the one or more fire safety devices. In an exemplary embodiment, the configuration device 108 may be configured to add the identified one or more fire safety devices to the project. The project may define the complete hierarchical structure of the one or more identified fire safety devices and corresponding operation nodes. The operation nodes may correspond to a fire control panel configured to control operations and/or functions of the corresponding one or more fire safety devices. In one embodiment, the operational nodes may be represented using the one or more machine readable codes 104 in the floor layout 102. Also, the configuration device 108 may be configured to generate the project using the one or more machine readable codes 104 representing the one or more operational nodes and/or the one or more fire safety devices. In some embodiments, the configuration device 108 may configure the one or more operational nodes to control and/or monitor operations and/or functions of the one or more fire safety devices based on the information stored in the corresponding one or more machine readable codes 104.

In one embodiment, the configuration device 108 may be configured to extract the physical locations of the one or more fire safety devices and generate the project representing the one or more fire safety devices in a structured tree-based architecture. This enables the user to easily configure the one or more fire safety devices.

In one embodiment, the configuration device 108 may also determine one or more configuration models to be used for the fire safety devices. The configuration device 108 may determine a number of addresses corresponding to the determined one or more configuration models. Thereafter, the configuration device 108 may assign each fire device for each address corresponding to a specific physical location. For instance, a model CT2 includes 2 addresses, a model REL includes 6 addresses, and a model PCOS contains 1 address.

In one embodiment, the configuration device 108 may configure a Signalling Line Circuit (SLC) card to the operational node and map the determined one or more configuration models to the SLC card. The SLC card may be configured to autonomously assign the one or more fire safety devices to different addresses based on the mapped one or more configuration models.

In one non-limiting embodiment, the addresses may be assigned in the below format:

{Fire Control Panel Address}:{SLC card address}:{fire device address}

In one embodiment, the configuration device 108 may be configured to determine a number of fire safety devices from the received input. The configuration device 108 may identify a number of the operational nodes based on the determined number of fire safety devices. Thereafter, the configuration device 108 may assign the one or more fire safety devices to the at least one operation node based on the identified number of operational nodes. In an embodiment, the configuration device 108 may identify the fire safety requirement of the building/environment based on the floor layout 102. The configuration device 108 may also identify the physical location and the number of the one or more fire safety devices based on the one or more machine readable codes 104. Thereafter, based on the total number of the fire safety devices and their corresponding physical locations, and the identified fire safety requirement of the building/environment, the configuration device 108 may identify the number of operational nodes (fire control panels/systems). The configuration device 108 may identify the operational node such as, the one or more fire safety devices are effectively assigned to at least one operation node.

In some embodiments, the configuration device 108 may receive one or more user inputs corresponding to the generated floor-based plan of the environment. The configuration device 108 may be configured to modify the generated floor-based plan based on the received one or more user inputs. The user inputs may represent any change in the one or more fire safety devices. Such a change may include, but is not limited to, a replacement, a removal, an addition, or a change of operational state of the one or more fire safety devices. The configuration device 108 may dynamically update the generated floor-based plan based on the received user input.

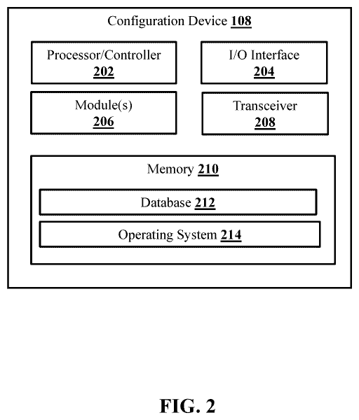

FIG. 2 illustrates a schematic block diagram of the configuration device 108 (also referred to as “the apparatus 108”), according to one or more embodiments of the present disclosure. In an embodiment, the configuration device 108 may be included within an electronic/user device associated with a user, for example, a computer system, a tablet, a control panel, or a server.

The configuration device 108 may be configured to receive and process the one or more machine readable codes 104 embedded with the CAD file corresponding to the floor layout 102. The configuration device 108 may include a processor/controller 202, an Input/Output (I/O) interface 204, one or more modules 206, a transceiver 208, and a memory 210.

In an exemplary embodiment, the processor/controller 202 may be operatively coupled to each of the I/O interface 204, the modules 206, the transceiver 208 and the memory 210. In one embodiment, the processor/controller 202 may include at least one data processor for executing processes in Virtual Storage Area Network. The processor/controller 202 may include specialized processing units such as, integrated system (bus) controllers, memory management control units, floating point units, graphics processing units, digital signal processing units, etc. In one embodiment, the processor/controller 202 may include a Central Processing Unit (CPU), a Graphics Processing Unit (GPU), or both. The processor/controller 202 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 202 may execute a software program, such as code generated manually (i.e., programmed) to perform the desired operation.

The processor/controller 202 may be disposed in communication with one or more input/output (I/O) devices via the I/O interface 204. The I/O interface 204 may employ communication Code-Division Multiple Access (CDMA), High-Speed Packet Access (HSPA+), Global System for Mobile communications (GSM), Long-Term Evolution (LTE), WiMax, or the like, etc.

Using the I/O interface 204, the configuration device 108 may communicate with one or more I/O devices (such as, the scanner device 106). Other examples of the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light Emitting Diode (LED), plasma, Plasma Display Panel (PDP), Organic Light-Emitting Diode display (OLED) or the like), audio speaker, etc.

The processor/controller 202 may be disposed in communication with a communication network via a network interface. In an embodiment, the network interface may be the I/O interface 204. The network interface may connect to the communication network to enable connection of the configuration device 108 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In some embodiments, the memory 210 may be communicatively coupled to the at least one processor/controller 202. The memory 210 may be configured to store data, instructions executable by the at least one processor/controller 202. In one embodiment, the memory 210 may communicate via a bus within the configuration device 108. The memory 210 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the figures or described may be performed by the programmed processor/controller 202 for executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some embodiments, the modules 206 may be included within the memory 210. The memory 210 may further include a database 212 to store data. The one or more modules 206 may include a set of instructions that may be executed to cause the configuration device 108 to perform any one or more of the methods/processes disclosed herein. In some embodiments, the modules 206 may be configured to perform one or more operations of the processor 202 to achieve the desired objective of the present disclosure. The one or more modules 206 may be configured to perform the steps of the present disclosure using the data stored in the database 212, to generate a floor-based plan of the one or more fire safety devices for the environment as discussed herein. In an embodiment, each of the one or more modules 206 may be a hardware unit which may be outside the memory 210. Further, the memory 210 may include an operating system 214 for performing one or more tasks of the configuration device 108, as performed by a generic operating system in the communications domain. The transceiver 208 may be configured to receive and/or transmit signals to and from an electronic device associated with the user. In one embodiment, the database 212 may be configured to store the information as required by the one or more modules 206 and the processor/controller 202 to perform one or more functions for generating the floor-based plan of the one or more fire safety devices.

Further, the present invention contemplates a computer-readable medium that includes instructions or receives and executes instructions responsive to a propagated signal. Further, the instructions may be transmitted or received over the network via a communication port or interface or using a bus (not shown). The communication port may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. Likewise, the additional connections with other components of the configuration device 108 may be physical or may be established wirelessly. The network may alternatively be directly connected to the bus.

For the sake of brevity, the architecture, and standard operations of the operating system 214, the memory 210, the database 212, the processor/controller 202, the transceiver 208, and the I/O interface 204 are not discussed in detail.

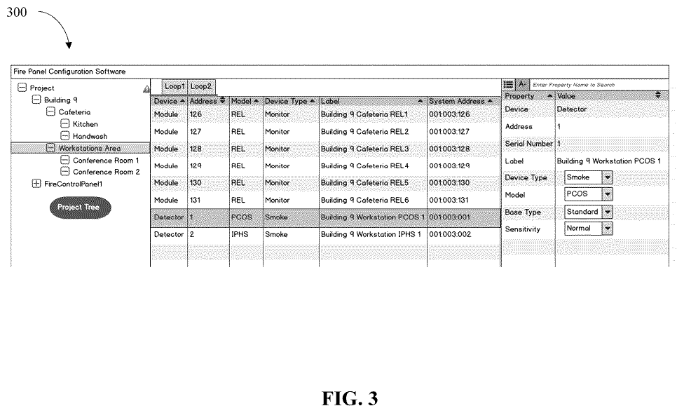

FIG. 3 illustrates a user interface (UI) 300 representing configuration of the fire safety devices by the configuration device, according to one or more embodiments of the present disclosure. The UI 300 may correspond to the floor-based plan of the one or more fire safety devices generated by the configuration device 108 based on the one or more machine readable codes. The UI 300 may illustrate the structured tree-based architecture of the building with respect to the one or more fire safety devices as identified based on the one or more machine readable codes. In the illustrated embodiment, the UI 300 corresponds to a project tree, outputted as a result of a selection of one of the floors for e.g. “workstations Area”. The fire devices located in that the corresponding are displayed in a centre grid, and on a right side of the UI 300, different properties of the selected fire device are displayed enabling the user to view and/or modify the configuration of the fire device based on the requirement.

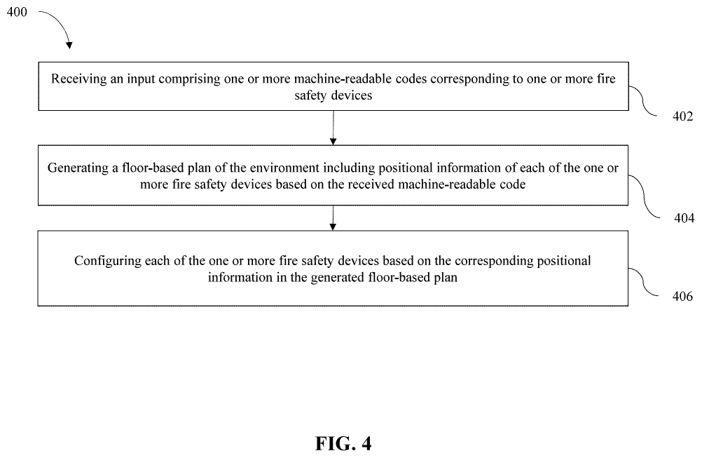

FIG. 4 illustrates a process flow depicting a method 400 for configuring the fire safety devices in the environment, according to one or more embodiments of the present disclosure. The method 400 may be implemented by the configuration device 108 and/or the one or more processors 202.

At step 402, the method 400 includes receiving an input comprising one or more machine-readable codes corresponding to one or more fire safety devices.

At step 404, the method 400 includes generating a floor-based plan of the environment including positional information of each of the one or more fire safety devices based on the received machine-readable code.

At step 406, the method 400 includes configuring each of the one or more fire safety devices based on the corresponding positional information in the generated floor-based plan.

While the above steps of FIG. 4 are shown and described in a particular sequence, the steps may occur in variations to the sequence in accordance with various embodiments of the disclosure. Further, the details related to various steps of FIG. 4, which are already covered in the description related to FIGS. 1-3 are not discussed again in detail here for the sake of brevity.

The disclosure provides a configuration device configured to embed and/or read the fire safety device as one or more machine readable codes. Thus, the configuration device enables easy and effective commissioning of the fire safety devices directly via the floor layout and/or the corresponding CAD file.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for configuring fire safety devices in an environment, comprising:
receiving an input comprising one or more machine-readable codes corresponding to one or more fire safety devices, wherein each of the one or more machine-readable codes includes at least one of device model information and a logical path associated with the corresponding fire safety device;
generating a floor-based plan of the environment including positional information of each of the one or more fire safety devices based on the received one or more machine-readable codes; and
configuring each of the one or more fire safety devices based on the corresponding positional information in the generated floor-based plan.

2. The method of claim 1, wherein receiving the input comprising one of:
receiving, via a scanning device, the one or more machine-readable codes; or
receiving a Computer Aided Design (CAD) file including the one or more machine-readable code.

3. The method of claim 1, wherein configuring each of the one or more fire safety devices comprises:
assigning the one or more fire safety devices to at least one operational node configured to control operation of the one or more fire safety devices.

4. The method of claim 1, wherein prior to receiving the input, the method comprising:
assigning, to each of the one or more fire safety devices, a machine-readable code to store at least one of the device model information and the logical path associated with the corresponding fire safety device: and
generating the CAD file with one or more machine-readable codes placed at a designated location of the corresponding one or more fire safety devices.

5. The method of claim 1, wherein configuring each of the one or more fire safety devices comprises:
determining a number of fire safety devices from the received input;
identifying a number of operational nodes based on the determined number of fire safety devices; and
assigning the one or more fire safety devices to the at least one operation node based on the identified number of operational nodes.

6. The method of claim 1, further comprising:
displaying the generated floor-based plan to a user via a user interface.

7. The method of claim 1, further comprising:
receiving, via a user interface, one or more user inputs corresponding to the generated floor-based architecture of the environment; and
modifying the generated floor-based plan based on the received one or more user inputs.

8. The method of claim 1, wherein the CAD file corresponds to a building map.

9. The method of claim 1, wherein the one or more machine-readable codes correspond to a Quick Response (QR) code.

10. An apparatus for configuring fire safety devices in an environment, comprising:
a memory; and
at least one processor communicably coupled with the memory, the at least one processor configured to:
receive an input comprising one or more machine-readable codes corresponding to one or more fire safety devices, wherein each of the one or more machine-readable codes includes at least one of device model information and a logical path associated with the corresponding fire safety device;
generate a floor-based plan of the environment including positional information of each of the one or more fire safety devices based on the received one or more machine-readable codes; and
configure each of the one or more fire safety devices based on the corresponding positional information in the generated floor-based plan.

11. The apparatus of claim 10, wherein the at least one processor is configured to:
receive, via a scanning device, the one or more machine-readable codes; or
receive a Computer Aided Design (CAD) file including the one or more machine-readable code.

12. The apparatus of claim 10, to configuring each of the one or more fire safety devices, the at least one processor is configured to:
assign the one or more fire safety devices to at least one operational node configured to control operation of the one or more fire safety devices.

13. The apparatus of claim 10, wherein prior to receiving the input, the at least one processor is configured to:
assign, to each of the one or more fire safety devices, a machine-readable code to store at least one of the device model information and the logical path associated with the corresponding fire safety device: and
generate the CAD file with one or more machine-readable codes placed at a designated location of the corresponding one or more fire safety devices.

14. The apparatus of claim 10, wherein to configure each of the one or more fire safety devices, the at least one processor is configured to:
determine a number of fire safety devices from the received input;
identify a number of operational nodes based on the determined number of fire safety devices; and
assign the one or more fire safety devices to the at least one operation node based on the identified number of operational nodes.

15. The apparatus of claim 10, wherein the at least one processor is configured to:
display the generated floor-based plan to a user via a user interface.

16. The apparatus of claim 10, wherein the at least one processor is configured to:
receive, via a user interface, one or more user inputs corresponding to the generated floor-based plan of the environment;
modify the generated floor-based plan based on the received one or more user inputs.

17. The apparatus of claim 10, wherein the one or more machine-readable codes correspond to a Quick Response (QR) code.
